(19) United States
(12) Patent Application Publication
(10) Pub. No.: US 2026/0361764 A1
(43) Pub. Date: Nov. 12, 2026

(54) CYBERATTACK DETECTION DEVICE AND CYBERATTACK DETECTION METHOD

(71) Applicant: Mitsubishi Electric Mobility Corporation, Tokyo (JP)

(72) Inventors: Toshiki IKEGASHIRA, Tokyo (JP); Katsuhisa OGASAWARA, Tokyo (JP); Yusuke SETO, Tokyo (JP)

(73) Assignee: Mitsubishi Electric Mobility Corporation, Tokyo (JP)

(21) Appl. No.: 19/122,498

(22) PCT Filed: Oct. 24, 2022
(86) PCT No.: PCT/JP2022/039427

§ 371 Date: Apr. 18, 2025

(51) Int. Cl. H04L 9/40

(52) U.S. Cl. CPC H04L 63/1458; H04L 63/1416; H04L 63/1425

(57) ABSTRACT

A cyberattack detection device includes: a communication header monitoring unit to monitor a header of received communication data; a communication monitoring unit to monitor payload of the communication data; an attack detection unit to detect a symptom of a DoS attack that brings about a malfunction; an additional information request unit to identify a sender from the communication data in a case where the symptom is detected, and to request the identified sender to add additional information to a header of communication data to be sent newly; and an updating unit to make an updating decision to add the additional information as a monitoring item in a case where the symptom is detected, wherein the communication header monitoring unit determines that communication data to be received newly is anomalous in a case where the additional information is not added to a header of the communication data to be received newly.

### TECHNICAL FIELD

The present disclosure relates to a cyberattack detection technology.

### BACKGROUND ART

As an example of cyberattack detection technologies, Patent Literature 1 discloses a technology related to a vehicle network device to perform communication of data between a plurality of vehicle-mounted devices. The vehicle network device has a condition acquisition unit that acquires the condition of a host vehicle, and a communication monitoring unit that monitors the data, and changes methods of monitoring the data on the basis of the condition of the host vehicle.

### CITATION LIST

### Patent Literature

Patent Literature 1: JP 2017-47835 A.

### SUMMARY OF INVENTION

### Technical Problem

The device disclosed in Patent Literature 1 simply changes the monitoring methods depending on the condition. Accordingly, the device has a problem that there is a possibility that the communication monitoring unit no longer functions if the device comes under attack called a Denial of Service (DoS) attack in which a large amount of communication data is sent.

The present disclosure has been made to solve such a problem, and an object thereof is to provide a cyberattack detection technology that can cope with a DoS attack.

### Solution to Problem

An aspect of a cyberattack detection device of the present disclosure includes: a communication header monitoring unit to monitor a header of received communication data; a communication monitoring unit to monitor payload of the communication data; an attack detection unit to detect, from the communication data, a symptom of a DoS attack that brings about a malfunction of the communication monitoring unit; an additional information request unit to identify a sender from the communication data in a case where the symptom is detected, and to request the identified sender to add additional information to a header of communication data to be sent newly; and an updating unit to make an updating decision to add the additional information as a monitoring item in a case where the symptom is detected, in which the communication header monitoring unit adds the additional information as the monitoring item on a basis of the updating decision, and determines that communication data to be received newly is anomalous in a case where the additional information is not added to a header of the communication data to be received newly or information added to the header of the communication data to be received newly does not match the additional information.

### Advantageous Effects of Invention

The cyberattack detection technology of the present disclosure can cope with a DoS attack.

### BRIEF DESCRIPTION OF DRAWINGS

FIG. 1 is a functional block diagram of a control device.

FIG. 2 is an explanatory diagram for explaining an operation performed by a communication header monitoring unit to determine that communication data is anomalous.

FIG. 3 is an explanatory diagram for explaining an operation performed by the communication header monitoring unit to determine that communication data is anomalous.

FIG. 4 is an explanatory diagram for explaining an operation performed by the communication header monitoring unit to determine that communication data is anomalous.

FIG. 5 is a flowchart illustrating an anomaly detection process performed in a case where there is not an ongoing DoS attack.

FIG. 6 is a flowchart illustrating a symptom determination process of determining a symptom of a DoS attack.

FIG. 7 is a flowchart illustrating an anomaly detection process performed in a case where a symptom of a DoS attack is sensed.

### DESCRIPTION OF EMBODIMENTS

Hereinafter, various embodiments according to the present disclosure are explained in detail with reference to the attached drawings. Note that constituent elements that are given identical or similar reference signs in the drawings have identical or similar configurations or functions, and overlapping explanation of such constituent elements is omitted.

### First Embodiment

### Outline of Configurations

### (Control Device)

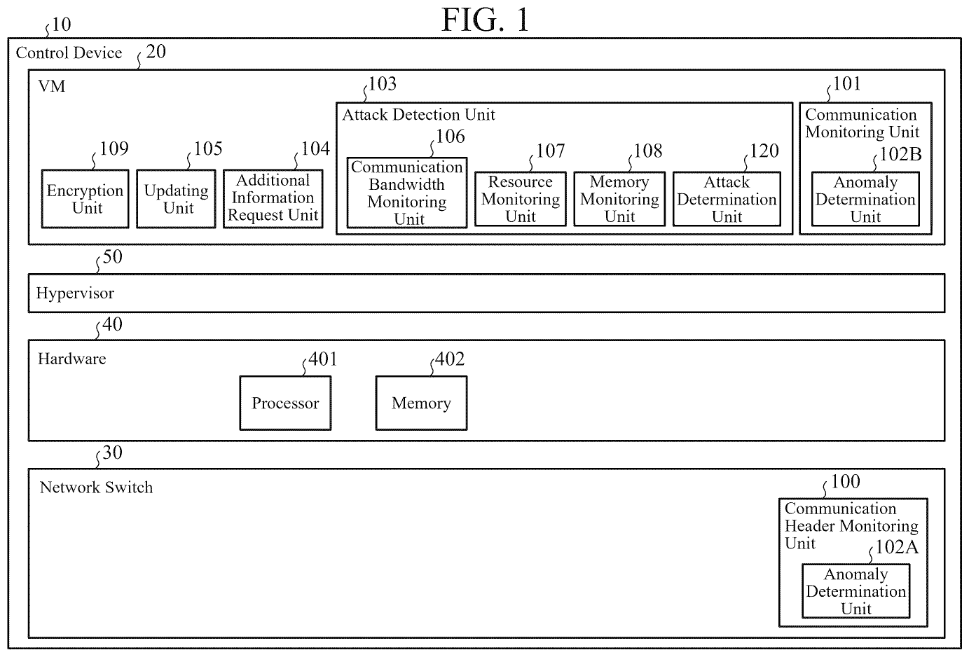

FIG. 1 is a functional block diagram of a control device in a case where a cyberattack detection device of the present disclosure is applied as a vehicle-mounted electronic control device (hereinafter, simply referred to as a “control device”). A control device 10 is a device to control an unillustrated vehicle. The control device 10 is connected with other unillustrated control devices inside the vehicle via an unillustrated communication line, for example Ethernet or a Controller Area Network (CAN). The control device 10 includes a Virtual Machine (VM) 20, a network switch 30, a hardware 40, and a hypervisor 50.

### (Network Switch)

The network switch 30 is a network switch that connects the control device 10 and other unillustrated control devices inside the vehicle. For example, the network switch 30 is an Ethernet switch having a security function. As an example, as illustrated in FIG. 1, the network switch 30 may include a communication header monitoring unit 100, and monitor the header of communication data. Functions of or operations performed by the communication header monitoring unit 100 are described later in more detail.

### (VM)

The Virtual Machine (VM) 20 is a virtual machine having a function to control the vehicle. For example, the VM 20 includes Linux (registered trademark), which is an operating system (OS). The VM 20 includes a communication monitoring unit 101, an attack detection unit 103, an additional information request unit 104, an updating unit 105, and an encryption unit 109. Details of the functional units are described later.

### (Hardware)

The hardware 40 is hardware of the control device 10, and includes a processor 401 and a memory 402. The hardware 40 may have a function to route communication data and a security function.

The processor 401 performs a function executed by each functional unit of the VM 20 by executing a program stored on the memory 402. In addition, the processor 401 performs a function executed by the communication header monitoring unit 100 by executing a program stored on the memory 402. Examples of the memory 402 include non-volatile or volatile semiconductor memories such as random access memory (RAM), read-only memory (ROM), flash memory, erasable programmable read only memory (EPROM), or electrically erasable programmable read-only memory (EEPROM), magnetic disks, flexible discs, optical discs, compact discs, mini discs, and DVDs.

### (Hypervisor)

The hypervisor 50 is a hypervisor of the control device 10, and is software for causing one VM 20 or two or more VMs 20 to operate on the hardware 40. Typically, a hypervisor is software for causing a plurality of different operating systems to run simultaneously on hardware. Accordingly, the hypervisor 50 may not be provided in a case where the control device 10 includes a single VM 20. The hypervisor 50 may have a function to route communication data and a security function.

### Details of Configurations

### (Communication Header Monitoring Unit)

As an example, the network switch 30 may include the communication header monitoring unit 100 including an anomaly determination unit 102A.

The communication header monitoring unit 100 is a functional unit having a function to send and receive communication data to and from an unillustrated control device other than the control device 10, and inspect the header of the communication data. For example, the communication header monitoring unit 100 sends and receives communication data of Ethernet communication, and inspects the header of the communication data.

The anomaly determination unit 102A retains, as normal values, a list of normal-time communication data, and has a function to compare, with the normal values, newly acquired communication data as monitoring results. Note that the list of normal-time communication data is created by an unillustrated control unit of the VM 20 when the control device 10 is operating normally, and is retained in a memory. The anomaly determination unit 102A acquires and retains the created list by referring to the memory.

For example, the inspection of the header of communication data includes any one of inspection on Layer 2, inspection on Layer 3, and inspection on Layer 4 in a case of communication data of Ethernet communication.

For example, the inspection on Layer 2 includes inspection of a sender Media Access Control (MAC) address, inspection of a destination MAC address, and inspection of a Virtual LAN (VLAN) port.

For example, the inspection of Layer 3 includes inspection of a sender Internet Protocol (IP) address and inspection of a destination IP address.

For example, the inspection of Layer 4 includes inspection of a sender port number, a destination port number, and a Transmission Control Protocol (TCP) flag.

Although FIG. I illustrates a configuration in which the network switch 30 includes the communication header monitoring unit 100, the communication header monitoring unit 100 may be disposed in any one of the hardware 40, the hypervisor 50, and the VM 20. In addition, a communication header monitoring unit may be disposed for each layer. For example, a communication header monitoring unit to perform the inspection on Layer 2 may be disposed in the network switch 30, communication header monitoring units to perform the inspection on Layer 3 and Layer 4 may be disposed in the hardware 40.

### (Communication Monitoring Unit)

The communication monitoring unit 101 includes an anomaly determination unit 102B, and monitors an area other than the header of communication data monitored by the communication header monitoring unit 100, that is, payload information. For example, the payload information is data, the reception intervals, and the reception frequency of communication data.

The communication monitoring unit 101 may monitor the header of communication data monitored by the communication header monitoring unit 100. By configuring also the communication monitoring unit 101 to perform double-checking to monitor the header of communication data in addition to the communication header monitoring unit 100, it is possible to cause the communication monitoring unit 101 to monitor the header of communication data even in a case where the communication header monitoring unit 100 does not operate normally.

The anomaly determination unit 102B retains, as normal values, the list of normal-time communication data, and has a function to compare, with the normal values, newly acquired communication data as monitoring results. Note that the list of normal-time communication data is created by an unillustrated control unit of the VM 20 when the control device 10 is operating normally, and is retained in a memory. The anomaly determination unit 102B acquires and retains the created list by referring to the memory. The anomaly determination unit 102B determines that newly acquired communication data is anomalous in a case where the monitoring result and the normal values do not match as a result of comparison.

The anomaly determination unit 102B can interrupt communication as an anomaly handling process in a case where it is determined that newly acquired communication data is anomalous. Other anomaly handling processes may be implemented. For example, examples of other anomaly handling process include: switching communication lines; switching of the control device 10 to a stand-by control device, and restriction of functions of the control device 10. In a case where it is determined that newly acquired communication data is normal, execution of a control process of the control device 10 which is performed usually is continued.

### (Attack Detection Unit)

The attack detection unit 103 is a functional unit to perform a symptom determination function to determine whether or not there is a symptom of a DoS attack as an incident. In a case where there is a DoS attack, the communication monitoring unit 101 no longer functions. Accordingly, the communication monitoring unit 101 is prevented from malfunctioning by detecting a symptom of a DoS attack. Additionally, in a case where a DoS attack has subsided, the attack detection unit 103 may perform an attack end determination function to determine that there is not an ongoing attack. In order to perform the symptom determination function, and additionally the attack end determination function, the attack detection unit 103 includes a communication bandwidth monitoring unit 106, a resource monitoring unit 107, a memory monitoring unit 108, and an attack determination unit 120.

### (Communication Bandwidth Monitoring Unit)

The communication bandwidth monitoring unit 106 is a functional unit to monitor a communication bandwidth usage which is the usage of a communication bandwidth that the communication monitoring unit 101 uses at the time of communication data reception, and determine whether there is a communication bandwidth to spare. For example, an upper limit value is set on the basis of the normal-time communication bandwidth, and determines that there is an anomaly in a case where the communication bandwidth exceeds the set upper limit value.

### (Resource Monitoring Unit)

The resource monitoring unit 107 has a function to monitor the processing load of the communication monitoring unit 101, and determine whether there is processing load to spare. For example, the resource monitoring unit 107 compares a normal-time processor usage rate and the current processor usage rate of a processor allocated to the resource monitoring unit 107, and determines whether or not there is an anomaly.

### (Memory Monitoring Unit)

The memory monitoring unit 108 has a function to monitor the memory usage of the communication monitoring unit 101, and determine whether there is a space to spare in a memory. For example, the memory monitoring unit 108 compares a normal-time memory usage and the current memory usage of a memory allocated to the memory monitoring unit 108, and determines whether or not there is an anomaly.

### (Attack Determination Unit)

On the basis of monitoring results of the communication bandwidth monitoring unit 106, the resource monitoring unit 107, and the memory monitoring unit 108, the attack determination unit 120 determines whether or not there is a symptom of an incident by a DoS attack. The attack determination unit 120 may determine that there is a symptom in a case where monitoring results of all of the communication bandwidth monitoring unit 106, the resource monitoring unit 107, and the memory monitoring unit 108 are anomalous, or may determine that there is a symptom in a case where a monitoring result of any one of them is anomalous. Furthermore, it may be determined whether there is a symptom of an incident taking into account also the vehicle condition. For example, the upper limit of the processing load during traveling of the vehicle may be set stricter.

The attack detection unit 103 may operate on the basis of an anomaly result of the communication monitoring unit 101. For example, the attack detection unit 103 may be configured to operate in a case where an anomaly result of the communication monitoring unit 101 represents an interval anomaly.

The attack detection unit 103 transfers a sensing result representing that there is a symptom of an incident to the additional information request unit 104 and the updating unit 105 in a case where the symptom is sensed.

### (Additional Information Request Unit)

The additional information request unit 104 is a functional unit to identify a sender from a large amount of received communication data in a case where the attack detection unit 103 determines that there is a symptom of an incident, and requests the sender to attach additional information to the header of communication data to be sent newly. For example, in a case where there is an attack by spoofing of the IP address of an authorized device, a large amount of communication data of the spoofed authorized device has been received. Accordingly, the sender authorized device, which has been spoofed, is requested to attach the additional information to a header.

Note that identifying the sender includes narrowing down a range to a certain degree, in addition to uniquely identifying the address of the sender.

The additional information is dynamic information that changes every time the additional information is sent or is dynamic information that changes over time, or encryption information obtained by encrypting the dynamic information. Examples of the dynamic information includes a counter value and a timestamp.

The additional information request unit 104 may select a random value or a random item as the additional information. As an example, the additional information request unit 104 selects, as the additional information, a counter value incremented from a random number. As an example, the additional information request unit 104 randomly selects, as the additional information, a counter value or a timestamp. That is, instead of selecting a counter value every time, a counter value is selected sometimes, and a timestamp is selected other times.

The additional information request unit 104 may request to add, as the additional information, information encrypted using a predetermined encryption key described later.

In addition, the additional information request unit 104 may make a removal request asking to remove the additional information that the sender has been requested to add in a case where, after a request asking to attach the additional information has been made, a symptom of an incident is no longer detected by the attack detection unit 103.

The additional information requested by the additional information request unit 104 is transferred to the updating unit 105, in addition to being sent to the sender. In addition, in one embodiment, the additional information may be transferred to the encryption unit 109.

### (Encryption Unit)

The encryption unit 109 is a functional unit to encrypt the additional information that the additional information request unit 104 requests. For example, the encryption unit 109 encrypts a counter value or a timestamp. For example, Message Authentication Code (MAC), common key encryption, or public key cryptography is used for the encryption.

It is assumed that the encryption key used by the encryption unit 109 is retained also at the authorized sender in advance. That is, the control device 10 and the authorized sender retain the same common key.

The encryption process is implemented at the VM 20 or the hardware 40. For example, the encryption uses a fast Hardware Security Module (HSM).

### (Updating Unit)

The updating unit 105 is a functional unit that makes an updating decision to add the additional information as an monitoring item about communication data in a case where the additional information request unit 104 requests the sender to attach the additional information to the header of communication data. The communication header monitoring unit 100 updates monitoring items on the basis of the updating decision. The updating of the monitoring items may be performed by the updating unit 105 or may be performed by the communication header monitoring unit 100. In a case where the communication header monitoring unit 100 updates the monitoring items, the updating unit 105 transfers an instruction for updating the monitoring items to the communication header monitoring unit 100 on the basis of the updating decision. Part of communication data may be monitored as binary data.

In addition, the updating unit 105 may make a removal updating decision to remove the additional information from the monitoring items about communication data in a case where the additional information request unit 104 makes a removal request asking to remove the additional information. On the basis of the updating decision, the monitoring items of the communication header monitoring unit 100 are updated. That is, the additional information is removed from the monitoring items of the communication header monitoring unit 100.

### (Details of Anomaly Determination Technique)

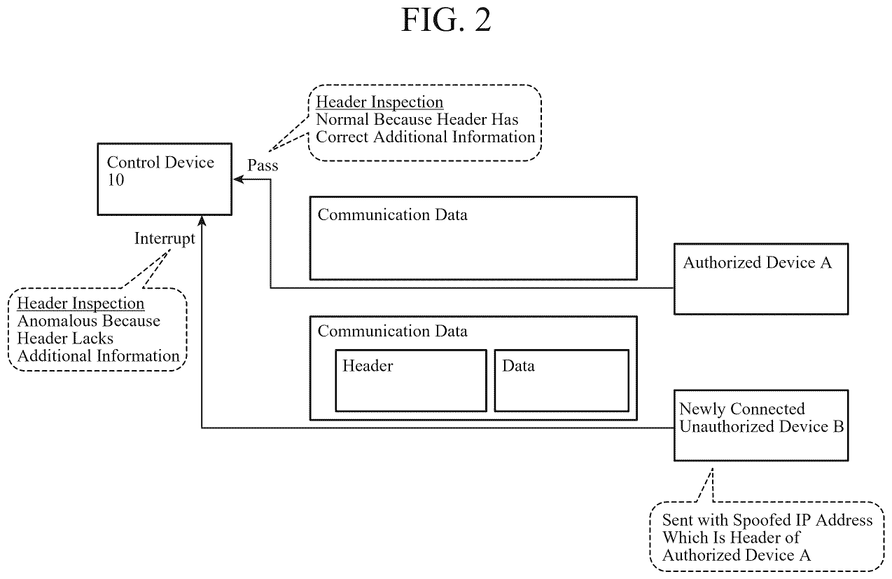

Hereinafter, a detailed procedure of an anomaly determination technique by which the communication header monitoring unit 100 determines that communication data is anomalous is explained with reference to FIGS. 2 to 4.

FIG. 2 illustrates a technique to determine that there is an anomaly in a case where the additional information is added to the monitoring items of the communication header monitoring unit 100, and the header of communication data does not have the additional information. A newly connected unauthorized device B is about to carry out a DoS attack on the control device 10 by spoofing the IP address of the header of an authorized device A.

In the control device 10, the attack detection unit 103 detects a symptom of an incident (DoS attack). In a case where a symptom is detected, the additional information request unit 104 identifies a sender from a large amount of received communication data, and requests the sender to attach the additional information. In addition, in a case where a symptom is detected, the updating unit 105 makes an updating decision to add the additional information as a monitoring item of the communication header monitoring unit 100. On the basis of this updating decision, the additional information is added as a monitoring item of the communication header monitoring unit 100.

The control device 10 (additional information request unit 104) requests the sender authorized device A to attach the additional information. On the other hand, communication data for requesting the additional information does not reach the unauthorized device B since the unauthorized device B is simply spoofing the authorized device A.

After the addition request for the additional information is made, the authorized device A sends, to the control device 10, communication data with the additional information being attached to its header. In the control device 10 that receives the communication data, the anomaly determination unit 102A determines that the communication data from the authorized device A is normal on the basis of a monitoring result of the communication header monitoring unit 100.

On the other hand, the unauthorized device B sends, to the control device 10, communication data without the additional information being attached to its header. In the control device 10 that receives the communication data, the anomaly determination unit 102A determines that the communication data from the unauthorized device B is anomalous on the basis of a monitoring result of the communication header monitoring unit 100. In a case where it is determined that there is an anomaly, the communication header monitoring unit 100 may interrupt communication with the unauthorized device B.

In this manner, it is possible to detect an anomaly of communication data in a case where there is an ongoing attack with a spoofed IP address. In addition, it is possible to cope with a DoS attack even if the DoS attack is carried out, since anomalous communication is interrupted on the basis of a symptom of the DoS attack.

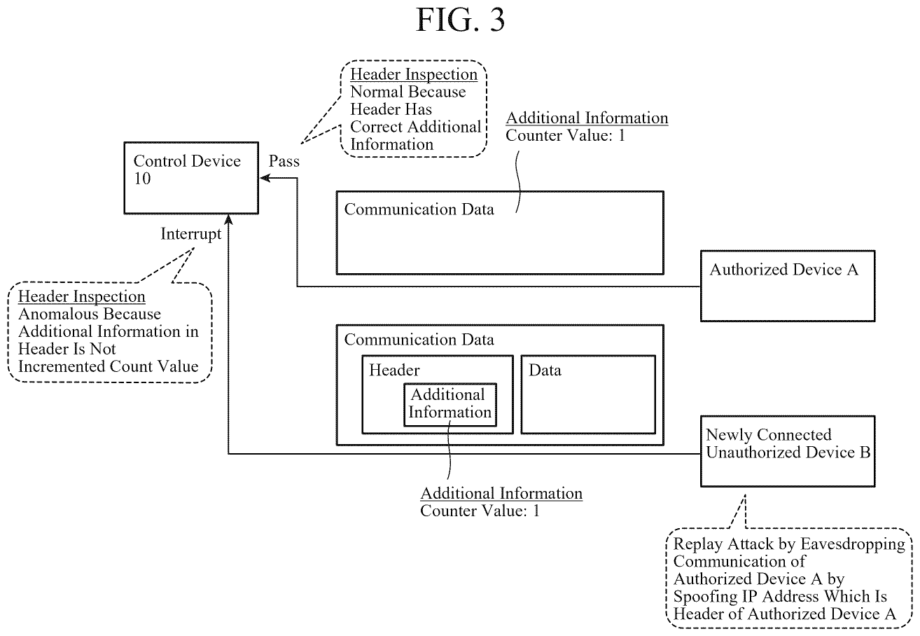

FIG. 3 illustrates a technique to determine that there is an anomaly in a case where the additional information is added to the monitoring items of the communication header monitoring unit 100, and the additional information attached to the header of communication data is not correct. The newly connected unauthorized device B is about to carry out a DoS attack on the control device 10 by eavesdropping communication of the authorized device A and imitatively adding the additional information by spoofing an IP address which is the header of the authorized device A.

In the control device 10, the attack detection unit 103 detects a symptom of an incident. In a case where a symptom is detected, the additional information request unit 104 identifies a sender from a large amount of received communication data, and requests the sender to attach the additional information. It is assumed that the additional information in the example illustrated in FIG. 3 is a counter value. In addition, in a case where a symptom is detected, the updating unit 105 makes an updating decision to add the additional information as a monitoring item of the communication header monitoring unit 100. On the basis of this updating decision, the additional information is added as a monitoring item of the communication header monitoring unit 100.

The control device 10 (additional information request unit 104) requests the sender authorized device A to attach the additional information. On the other hand, communication data for requesting the additional information does not reach the unauthorized device B since the unauthorized device B is simply spoofing the authorized device A. However, the unauthorized device B checks that additional information is attached, by eavesdropping communication of the authorized device A.

After the addition request for the additional information is made, the authorized device A sends, to the control device 10, communication data with a counter value 1 as the correct additional information being attached to its header. In the control device 10 that receives the communication data, the anomaly determination unit 102A determines that the communication data from the authorized device A is normal on the basis of a monitoring result of the communication header monitoring unit 100.

On the other hand, the unauthorized device B sends, to the control device 10, communication data with the counter value 1 of the eavesdropped additional information being attached by eavesdropping communication of the authorized device A and spoofing an IP address which is the header of the authorized device A. In the control device 10 that receives the communication data, the anomaly determination unit 102A determines that the communication data from the unauthorized device B is anomalous on the basis of a monitoring result of the communication header monitoring unit 100 since the counter value is not incremented. In a case where it is determined that there is an anomaly, the communication header monitoring unit 100 may interrupt communication with the unauthorized device B.

In this manner, it is possible to detect an anomaly of communication data in a case where there is an ongoing replay attack with a spoofed IP address. In addition, it is possible to cope with a DoS attack even if the DoS attack is carried out, since anomalous communication is interrupted on the basis of a symptom of the DoS attack.

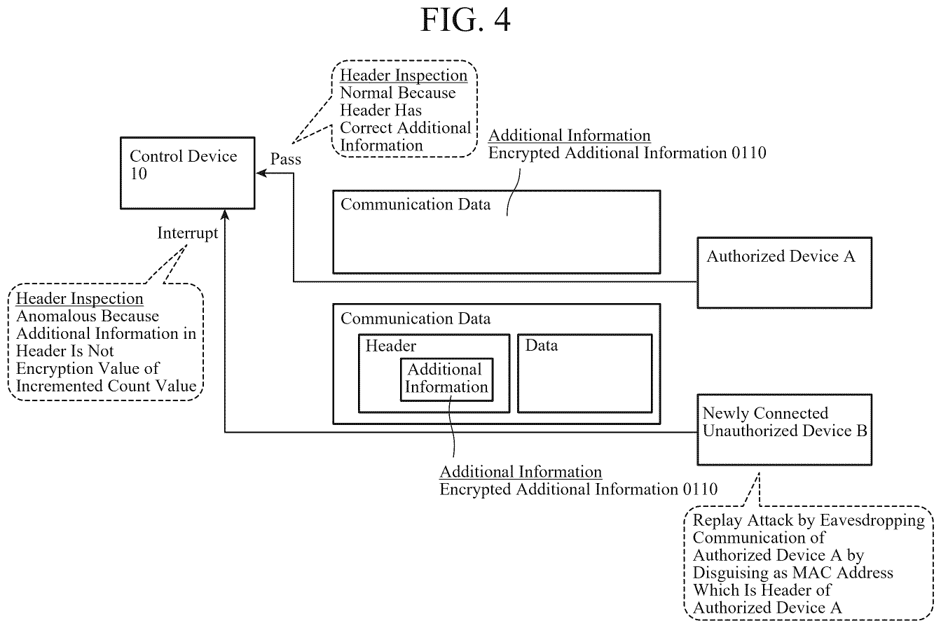

FIG. 4 illustrates a technique to determine that there is an anomaly in a case where the additional information is added to the monitoring items of the communication header monitoring unit 100, and the encrypted additional information attached to the header of communication data is not correct. The newly connected unauthorized device B is about to carry out a DoS attack on the control device 10 by eavesdropping communication of the authorized device A and imitatively adding the additional information by disguising its MAC address as a MAC address which is the header of the authorized device A and spoofing the authorized device A.

In the control device 10, the attack detection unit 103 detects a symptom of an incident. In a case where a symptom is detected, the additional information request unit 104 identifies a sender from a large amount of received communication data, and requests the sender to attach the additional information obtained by encrypting predetermined information. It is assumed that the additional information in the example illustrated in FIG. 4 is information obtained by encrypting a counter value. In addition, in a case where a symptom is detected, the updating unit 105 makes an updating decision to add the additional information as a monitoring item of the communication header monitoring unit 100. On the basis of this updating decision, the additional information is added as a monitoring item of the communication header monitoring unit 100.

The control device 10 (additional information request unit 104) requests the sender authorized device A to attach the additional information obtained by encrypting the counter value. On the other hand, the unauthorized device B is disguising its MAC address as the MAC address of the authorized device A. Accordingly, communication data for requesting to add the additional information reaches also the unauthorized device B undesirably.

After the addition request for the additional information is made, the authorized device A sends, to the control device 10, a header with additional information 0110 obtained by encrypting the counter value being attached thereto. In the control device 10 that receives the communication data, the anomaly determination unit 102A determines that the communication data from the authorized device A is normal on the basis of a monitoring result of the communication header monitoring unit 100.

On the other hand, the unauthorized device B sends, to the control device 10, communication data with the eavesdropped additional information 0110 being attached thereto by eavesdropping communication of the authorized device A and spoofing the header of the authorized device A. In the control device 10 that receives the communication data, the anomaly determination unit 102 determines that the communication data from the unauthorized device B is anomalous on the basis of a monitoring result of the communication header monitoring unit 100 since the additional information 0110 is not the additional information obtained by encrypting the incremented counter value. In a case where it is determined that there is an anomaly, the communication header monitoring unit 100 may interrupt communication with the unauthorized device B.

In this manner, it is possible to detect an anomaly of communication data in a case where there is an ongoing replay attack with a disguised MAC address. In addition, it is possible to cope with a DoS attack even if the DoS attack is carried out, since anomalous communication is interrupted on the basis of a symptom of the DoS attack.

### Operation

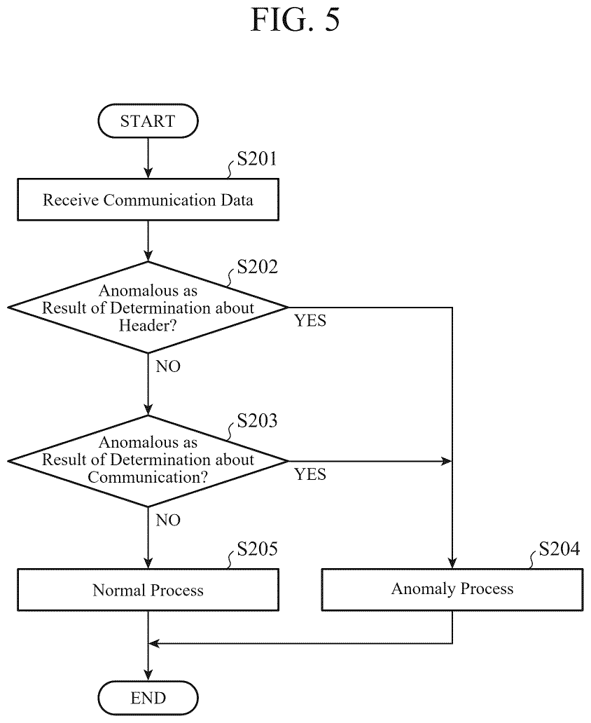

Hereinafter, operations related to a cyberattack detection method performed by control device 10 are explained with reference to FIGS. 5 to 7.

(Anomaly Detection Process Performed in Case where there is not Ongoing DoS Attack)

First, an anomaly detection process that is performed when the control device 10 is not receiving a DoS attack is explained in detail using FIG. 5. FIG. 5 is a flowchart illustrating the procedure of a series of processes from a communication data reception process through an anomaly determination process to execution of a process based on a determination result.

At Step S201, the communication header monitoring unit 100 receives communication data. After the process at Step S201 ends, the process proceeds to Step S202.

At Step S202, the communication header monitoring unit 100 inspects the header of the communication data. The anomaly determination unit 102A compares a monitoring result of the communication header monitoring unit 100 and the list of normal-time communication data, and determines whether the communication data is anomalous because it is unauthorized data. In a case where the communication data is determined as anomalous at Step S202, the process proceeds to Step S204. In a case where the communication data is determined as not anomalous (as normal) at Step S202, the process proceeds to Step S203.

At Step S203, the communication monitoring unit 101 inspects data of an area other than the header of the communication data. The anomaly determination unit 102B compares a monitoring result of the communication monitoring unit 101 and the list of normal-time communication data, and determines whether the communication data is anomalous because it is unauthorized data. In a case where the communication data is determined as anomalous at Step S203, the process proceeds to Step S204. In a case where the communication data is determined as normal at Step S203, the process proceeds to Step S205.

In a case where the communication data is determined as anomalous by the anomaly determination unit 102A or the anomaly determination unit 102B, at Step S204, the anomaly determination unit 102A or the anomaly determination unit 102B performs an anomaly process. For example, the anomaly determination unit 102A or the anomaly determination unit 102B interrupts communication determined as anomalous. After Step S204 ends, the anomaly detection process ends.

In a case where the communication data is determined as normal by the anomaly determination unit 102A and the anomaly determination unit 102B, at Step S205, the anomaly determination unit 102A and the anomaly determination unit 102B perform a normal process. The normal process means a control process that is performed as usual. After Step S205 ends, the anomaly detection process ends.

(Symptom Determination Process of Determining Whether there is Symptom of DoS Attack)

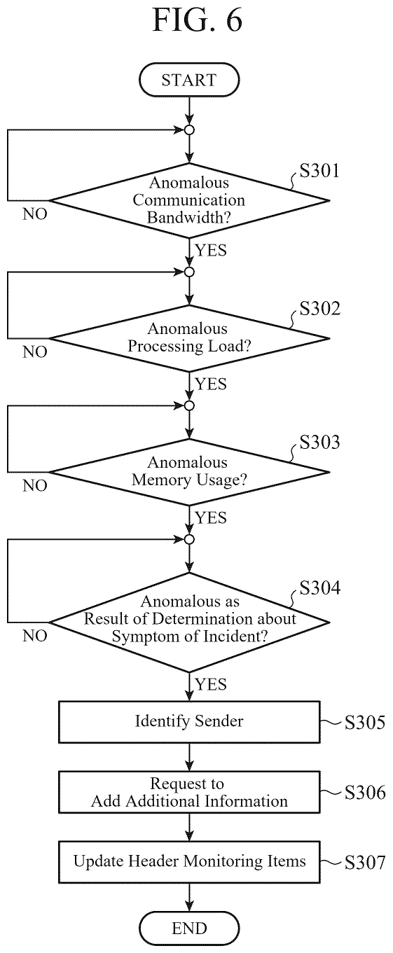

Next, a symptom determination process in which the control device 10 determines whether there is a symptom of a DoS attack is explained in detail using FIG. 6. FIG. 6 is a flowchart illustrating the procedure of a series of processes from performing symptom determination about an incident (DoS attack) through identifying a sender and requesting the sender to add additional information to updating the header monitoring items in such a manner that the additional information is added.

At Step S301, the communication bandwidth monitoring unit 106 monitors the communication bandwidth of the communication monitoring unit 101. In a case where the communication bandwidth exceeds a predetermined threshold, it is determined that there is an anomaly. In a case where it is determined at Step S301 that there is an anomaly, the process proceeds to Step S302.

At Step S302, the resource monitoring unit 107 monitors the processing load of the communication monitoring unit 101. In a case where the processing load exceeds a predetermined threshold, it is determined that there is an anomaly. In a case where it is determined at Step S302 that there is an anomaly, the process proceeds to Step S303.

At Step S303, the memory monitoring unit 108 monitors the memory usage of the communication monitoring unit 101. In a case where the memory usage exceeds a predetermined threshold, it is determined that there is an anomaly. After Step S303 ends, in a case where it is determined that there is an anomaly, the process proceeds to Step S304. Note that Step S301, Step S302, and Step S303 may be performed in any order.

At Step S304, the attack determination unit 120 determines whether there is a symptom of an incident by a DoS attack on the basis of an anomaly result of the communication bandwidth monitoring unit 106, an anomaly result of the resource monitoring unit 107, and an anomaly determination result of the memory monitoring unit 108. The attack determination unit 120 may determine that there is a symptom of an incident when any of the anomaly determination results represents that there is an anomaly. In a case where it is determined at Step S304 that there is a symptom of an incident, the process proceeds to Step S305.

At Step S305, the additional information request unit 104 identifies a sender from a large amount of received reception data. After the process at Step S305 ends, the process proceeds to Step S306.

At Step S306, the additional information request unit 104 requests the identified sender to add the additional information. The additional information request unit 104 may request encrypted information as the additional information. In this case, the encryption unit 109 encrypts an expected value (e.g. a counter value) of a monitoring item, and treats data obtained after the encryption as the additional information. After the process at Step S306 ends, the process proceeds to Step S307.

At Step S307, the updating unit 105 makes an updating decision to add, as a monitoring item about communication data, the additional information that the additional information request unit 104 has requested the sender to add. On the basis of this updating decision, as an example, the updating unit 105 adds the requested additional information to the monitoring items of the communication header monitoring unit 100. As another example, the communication header monitoring unit 100 may add the requested additional information to the monitoring items. After the process at Step S307 ends, the incident symptom determination process is ended.

(Anomaly Detection Process Performed in Case where Symptom of DoS Attack is Sensed)

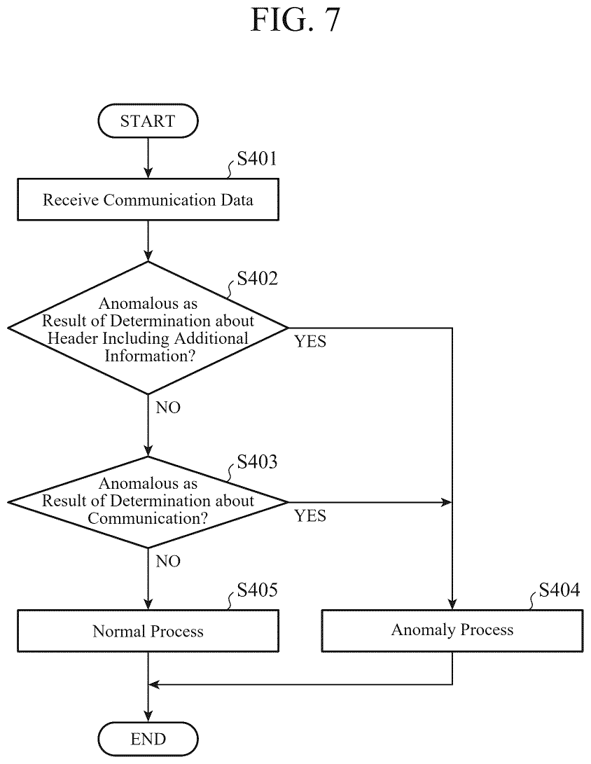

Next, an anomaly detection process performed in a case where the control device 10 has sensed a symptom of a DoS attack is explained in detail using FIG. 7. FIG. 7 is a flowchart illustrating the procedure of a series of processes from a communication data reception process through an anomaly detection process to execution of a process based on a determination result.

At Step S401, the communication header monitoring unit 100 receives communication data. After the process at Step S401 ends, the process proceeds to Step S402.

At Step S402, the communication header monitoring unit 100 inspects the header of the communication data. The anomaly determination unit 102A compares a monitoring result of the communication header monitoring unit 100 and the list of normal-time communication data to which the additional information has been added, and determines whether the communication data is anomalous because it is unauthorized data. In a case where the communication data is determined as anomalous at Step S402, the process proceeds to Step S404. In a case where the communication data is determined as not anomalous (as normal) at Step S402, the process proceeds to Step S403.

At Step S403, the communication monitoring unit 101 inspects data of an area other than the header of the communication data. The anomaly determination unit 102B compares a monitoring result of the communication monitoring unit 101 and the list of normal-time communication data, and determines whether the communication data is anomalous because it is unauthorized data. In a case where the communication data is determined as anomalous at Step S403, the process proceeds to Step S404. In a case where the communication data is determined as normal at Step S403, the process proceeds to Step S405.

In a case where the communication data is determined as anomalous by the anomaly determination unit 102A or the anomaly determination unit 102B, at Step S404, the anomaly determination unit 102A or the anomaly determination unit 102B performs an anomaly process. For example, the anomaly determination unit 102A or the anomaly determination unit 102B interrupts communication determined as anomalous. After Step 404 ends, the anomaly detection process ends.

In a case where the communication data is determined as normal by the anomaly determination unit 102A and the anomaly determination unit 102B, at Step S405, the anomaly determination unit 102A and the anomaly determination unit 102B performs a normal process. The normal process means a control process that is performed as usual. After Step 405 ends, the anomaly detection process ends.

Note that, in the example explained in the first embodiment explained above, the cyberattack detection device according to the present disclosure is used as a vehicle-mounted electronic control device. However, the cyberattack detection device according to the present disclosure is not limited to this example. For example, the cyberattack detection device can also be used as a device, connected to a communication line, and requiring a mechanism that has a high security level and detects an anomaly early.

According to the first embodiment explained above, advantages can be attained as explained below.

An aspect of a control device (cyberattack detection device) of the present disclosure includes: a communication header monitoring unit (100) to monitor a header of received communication data; a communication monitoring unit (101) to monitor payload of the communication data; an attack detection unit (103) to detect, from the communication data, a symptom of a DoS attack that brings about a malfunction of the communication monitoring unit, an additional information request unit (104) to identify a sender from the communication data in a case where the symptom is detected, and to request the identified sender to add additional information to a header of communication data to be sent newly; and an updating unit (105) to make an updating decision to add the additional information as a monitoring item in a case where the symptom is detected, in which the communication header monitoring unit (100) adds the additional information as a monitoring item on the basis of the updating decision, and determines that communication data to be received newly is anomalous in a case where the additional information is not added to a header of the communication data to be received newly or information added to the header of the communication data to be received newly does not match the additional information.

In this manner, a symptom of a DoS attack is detected, the sender is requested to add the additional information to the header of the sent data, and whether the requested additional information has been added is monitored. Accordingly, since a DoS attack is coped with in advance before the DoS attack is carried out, the control device (cyberattack detection device) of the present disclosure can cope with a DoS attack.

In addition, according to an aspect of the control device (cyberattack detection device) of the present disclosure, the communication header monitoring unit interrupts communication with the sender in a case where it is determined that the communication data to be received newly is anomalous. Accordingly, since the communication monitoring unit to monitor payload need not process a large amount of reception data, the processing load of the communication monitoring unit can be reduced.

In addition, according to an aspect of the control device (cyberattack detection device) of the present disclosure, in a case where the symptom of the DoS attack is not detected after the request for addition of the additional information is made, a removal request asking to remove the additional information that has been requested to be added is made. Accordingly, by dynamically attaching the additional information in this manner, it is possible to increase the possibility of being able to prevent a spoofing attack performed by eavesdropping and estimation.

In addition, according to an aspect of the control device (cyberattack detection device) of the present disclosure, the additional information is dynamic information that changes every time the additional information is sent or is dynamic information that changes over time. In this manner, by attaching the additional information whose value changes dynamically, it is possible to prevent an attack even if eavesdropping is performed and a replay attack is carried out.

In addition, according to an aspect of the control device (cyberattack detection device) of the present disclosure, the dynamic information is a timestamp or a counter value, and the additional information request unit randomly selects the timestamp or the counter value as the additional information, and the counter value is a value incremented from a random value in a case where the counter value is selected.

Accordingly, it is possible to increase the possibility of being able to prevent a spoofing attack performed by eavesdropping and estimation.

In addition, according to an aspect of the control device (cyberattack detection device) of the present disclosure, the control device further includes an encryption unit (109) to encrypt the dynamic information into encryption information using a predetermined encryption key, in which the additional information request unit requests the sender to add, as the additional information, information obtained by encrypting the dynamic information using the encryption key, the updating unit makes a further updating decision to add the encryption information as a monitoring item in a case where the symptom is detected, and the communication header monitoring unit adds the encryption information as a monitoring item on the basis of the further updating decision, and determines that communication data to be received newly is anomalous in a case where the encryption information is not added to a header of the communication data to be received newly or information added to the header of the communication data to be received newly does not match the encryption information.

According to such a configuration, it is possible to cope with a DoS attack by spoofing by disguising a MAC address.

Note that embodiments can be combined, and each embodiment can be modified, omitted, and so on as appropriate.

### INDUSTRIAL APPLICABILITY

For example, the cyberattack detection device of the present disclosure can be used as an electronic control device mounted on a vehicle.

### REFERENCE SIGNS LIST

10: control device (cyberattack detection device); 30: network switch; 40: hardware; 50: hypervisor; 100: communication header monitoring unit; 101: communication monitoring unit; 102 (102A, 102B): anomaly determination unit; 103: attack detection unit; 104: additional information request unit; 105: updating unit; 106: communication bandwidth monitoring unit; 107: resource monitoring unit; 108: memory monitoring unit; 109: encryption unit; 120: attack determination unit; 401: processor; 402: memory

1. A cyberattack detection device comprising:
a communication header monitor to monitor a header of received communication data;
a communication monitor to monitor payload of the communication data;
an attack detector to detect, from the communication data, a symptom of a DoS attack that brings about a malfunction of the communication monitor;
an additional information requester to identify a sender from the communication data in a case where the symptom is detected, and to request the identified sender to add additional information to a header of communication data to be sent newly; and
an updater to make an updating decision to add the additional information as a monitoring item in a case where the symptom is detected, wherein
the communication header monitor adds the additional information as the monitoring item on a basis of the updating decision, and determines that communication data to be received newly is anomalous in a case where the additional information is not added to a header of the communication data to be received newly or information added to the header of the communication data to be received newly does not match the additional information.

2. The cyberattack detection device according to claim 1, wherein the communication header monitor interrupts communication with the sender in a case where it is determined that the communication data to be received newly is anomalous.

3. The cyberattack detection device according to claim 1, wherein
the attack detector includes:
a communication bandwidth monitor to monitor a communication bandwidth usage of a communication bandwidth used by the communication monitor;
a resource monitor to monitor processing load of the communication monitor;
a memory monitor to monitor a memory usage of the communication monitor; and
an attack determinator to determine whether there is the symptom on a basis of some or all of the communication bandwidth usage, the processing load, and the memory usage.

4. The cyberattack detection device according to claim 1, wherein
in a case where the symptom is not detected after the request is made,
the additional information requester makes a removal request asking the identified sender to remove the additional information that has been requested to be added,
the updater makes a removal updating decision to remove the additional information from a monitoring item, and
the communication header monitor removes the additional information added as a monitoring item on a basis of the removal updating decision.

5. The cyberattack detection device according to claim 1, wherein the additional information is dynamic information that changes every time the additional information is sent or is dynamic information that changes over time.

6. The cyberattack detection device according to claim 5, wherein the communication header monitor determines that the communication data to be received newly is anomalous in a case where a value of the dynamic information does not increase or exceeds a predetermined upper limit value.

7. The cyberattack detection device according to claim 5, wherein
the dynamic information is a timestamp or a counter value, and
the additional information requester randomly selects the timestamp or the counter value as the additional information, and the counter value is a value incremented from a random value in a case where the counter value is selected.

8. The cyberattack detection device according to claim 5, further comprising an encryptor to encrypt the dynamic information into encryption information using a predetermined encryption key, wherein
the additional information requester requests the sender to add, as the additional information, information obtained by encrypting the dynamic information using the encryption key,
the updater makes a further updating decision to add the encryption information as a monitoring item in a case where the symptom is detected, and
the communication header monitor adds the encryption information as the monitoring item on a basis of the further updating decision, and determines that communication data to be received newly is anomalous in a case where the encryption information is not added to a header of the communication data to be received newly or information added to the header of the communication data to be received newly does not match the encryption information.

9. The cyberattack detection device according to claim 8, wherein the dynamic information is a timestamp or a counter value.

10. A cyberattack detection method comprising:
monitoring a header of received communication data;
monitoring payload of the communication data;
detecting, from the communication data, a symptom of a DoS attack that brings about a malfunction;
identifying a sender from the communication data in a case where the symptom is detected, and requesting the identified sender to add additional information to a header of communication data to be sent newly; and
making an updating decision to add the additional information as a monitoring item in a case where the symptom is detected, wherein
the cyberattack detection method further comprises adding the additional information as the monitoring item on a basis of the updating decision, and determining that communication data to be received newly is anomalous in a case where the additional information is not added to a header of the communication data to be received newly or information added to the header of the communication data to be received newly does not match the additional information.
